(19) United States
(12) Patent Application Publication
(10) Pub. No.: US 2026/0143253 A1
(43) Pub. Date: May 21, 2026

(54) MACHINE VISION MEASUREMENT SYSTEM AND METHOD FOR ADJUSTING SIMULATION PARAMETERS OF SENSOR CHIP

(71) Applicant: ZHEJIANG SENGO ADVANCED TECHNOLOGY CO., LTD., Jiaxing (CN)

(72) Inventors: Wenfu LI, Shanghai (CN); Jian LIU, Shanghai (CN); Dunshan YUAN, Shanghai (CN)

(73) Assignee: ZHEJIANG SENGO ADVANCED TECHNOLOGY CO., LTD., Jiaxing, ZJ (CN)

(21) Appl. No.: 19/450,768

(22) Filed: Jan. 16, 2026

Related U.S. Application Data
(63) Continuation of application No. PCT/CN2024/084847, filed on Mar. 29, 2024.

(30) Foreign Application Priority Data
Nov. 24, 2023 (CN) 202311586031.5

(51) Int. Cl. H04N 25/59; H04N 9/77; H04N 25/51

(52) U.S. Cl. CPC H04N 25/59; H04N 9/77; H04N 25/51

(57) ABSTRACT

A machine vision measurement system includes an image sensor chip, and a control processor including a HDR system module. The HDR system module includes: a data receiving module for synchronizing a row starting point and ending point; a data feature value analysis module for carrying out feature value extraction on serial data; a parameter decision feedback module for determining whether an extracted feature value is located in a preset optimal working area, keeping simulation parameters of the image sensor chip unchanged if so, and if not, adjusting the simulation parameters of the image sensor chip; a synchronous system control generator module for tracking a control working time sequence of the image sensor chip and starting up a data input detection window; and a synchronous simulation parameter output module for updating the simulation parameters of the image sensor chip based on a signal of the synchronous system control generator module.

This application is a continuation application of International Application No. PCT/CN2024/084847, filed on Mar. 29, 2024, which claims priority of Chinese Patent Application No. 202311586031.5, filed on Nov. 24, 2023, the entire contents of which are incorporated herein by reference.

### FIELD

The invention belongs to the field of measurement, in particular to a machine vision measurement system which implements intra-frame HDR by dynamic feedback and a method for adjusting simulation parameters of a sensor chip.

### BACKGROUND

High dynamic range (abbreviated to HDR) imaging refers to a set of techniques used in computer graphics and process photography to realize a wider exposure dynamic range (a greater contrast) as compared with common digital image techniques. In the field of industrial machine vision, HDR is often applied to scenarios with imaging interference caused by a great contrast or multiple reflections.

At present, existing methods include an inter-frame comparison method and a single-frame HDR method. The inter-frame comparison method acquires two or more frames of different images for comparison and then makes a decision and selection based on algorithm design. The inter-frame comparison method has two configurations: different exposure times and different gains, and requires an operating time of multiple frames; in addition, because different frames of images sampled may not correspond to the same position of a measured object in the operation process, introducing inter-frame interference. The single-frame HDR method may be implemented by means of a single frame and creates a nonlinear quantization method based on different exposure times. Because the single-frame HDR method is based on exposure times rather than actual optical responses, it cannot perform differentiated data processing, where necessary, in actual operation due to nonlinear conversion nodes, so the actual effect is limited, and it cannot give responses to different photo-sensitivities of measured objects. Although the single-frame HDR method realizes single-frame HDR, the actual frame rate of this method is merely about half of the frame rate of the HDR mode, and the single-frame HDR method and the inter-frame comparison method have almost the same influence on the frame rate.

The above methods have a significant influence on the high-frame-rate sampling requirement in the field of machine vision and will decrease the frame rate by almost half, thus not being suitable for the field of machine vision.

### SUMMARY

The objective of the invention is to provide a machine vision measurement system and a method for adjusting simulation parameters of a sensor chip to solve the problem that existing techniques have a great influence on the frame rate.

To achieve above objective, a machine vision measurement system is provided which comprises an image sensor chip and a control processor for cooperative use, the image sensor chip comprising a photoelectric sensor array, a sampling readout circuit, an operational amplifier, an analog-to-digital converter, an array exposure controller, a system control generator and a communication interface configuration module, and the control processor comprising a communication interface configuration module, a master control system, a data output system and a data processing system, wherein the control processor further comprises a HDR system module, and the HDR system module comprises:
a data receiving module, configured for synchronizing a row starting point and ending point on the basis of the number of row data;
a data feature value analysis module, configured for carrying out feature value extraction on serial data, wherein to be specific, the data feature value analysis module, after calibrating a starting point and an ending point of each row, receives data of each row and then carries out feature value extraction;
a parameter decision feedback module, configured for determining whether an extracted feature value of a current row is located in a preset optimal working area, keeping simulation parameters of the image sensor chip unchanged if so, adjusting the simulation parameters of the image sensor chip along a downtrend of the feature value if the feature value is located above the optimal working area, and adjusting the simulation parameters of the image sensor chip along an uptrend of the feature value if the feature value is located below the optimal working area;
a synchronous system control generator module, configured for tracking a control working time sequence of the image sensor chip and starting up a data input detection window; and

a synchronous simulation parameter output module, configured for updating the simulation parameters of the image sensor chip on the basis of a signal of the synchronous system control generator module.

According to the above main features, the feature value is one of a maximum value, a mean or a contrast of pixels.

According to the above main features, the simulation parameters comprise a gain parameter and a quantization parameter.

To achieve above objective, a method for adjusting simulation parameters of an image sensor chip by the machine vision measurement system described above is provided, the method comprising:
acquiring a decision range parameter, and setting an optimal working area of pixel features;
after the system is started, tracking a control working time sequence of the image sensor chip and starting up a data input detection window, by the synchronous system control generator module;
synchronizing, by the data receiving module, a row starting point and ending point on the basis of the number of row data;
carrying out, by the data feature value analysis module, feature value extraction on serial data, wherein the data feature value analysis module, after calibrating a starting point and an ending point of each row, receives data of each row and then carries out feature value extraction;
determining whether an extracted feature value of a current row is located in the preset optimal working area, keeping simulation parameters of the image sensor chip unchanged if so, adjusting the simulation parameters of the image sensor chip along a downtrend of the feature value if the feature value is located above the optimal working area, and adjusting the simulation parameters of the image sensor chip along an uptrend of the feature value if the feature value is located below the optimal working area, by the parameter decision feedback module; and
updating, by the synchronous simulation parameter output module, the simulation parameters of the image sensor chip on the basis of a synchronous system control signal.

According to the above main features, the feature value is one of a maximum value, a mean or a contrast of pixels.

According to the above main features, the simulation parameters comprise a gain parameter and a quantization parameter.

According to the above main features, adjusting the simulation parameters of the image sensor chip along the uptrend of the feature value comprises increasing a gain parameter and decreasing a quantization parameter, and adjusting the simulation parameters of the image sensor chip along the downtrend of the feature value comprises decreasing the gain parameter and increasing the quantization parameter.

According to the above main features, the simulation parameters comprise a gain parameter and a quantization parameter, and the method for adjusting the simulation parameter of the image sensor chip comprises:
establishing a value table of an equivalent gain according to possible values of the gain parameter and a quantization voltage, wherein the equivalent gain is a ratio of the gain parameter to the quantization voltage;
acquiring a feature value V₀ of a current row and an equivalent gain K₀;
determining a magnification factor K′, wherein the magnification factor K′ is a quotient of an expected equivalent gain K₁ and the equivalent gain K₀;
enumerating new expected target values corresponding to all magnification factors, wherein the new expected target values are obtained by multiplying the feature value V₀ of the current row by the magnification factors K′; and
determining the amplification factor K′ according to the new expected target value within the optimal working area; then, determining the expected equivalent gain K′; and then, determining the gain parameter and the quantization parameter corresponding to the expected equivalent gain K′.

According to the above main features, in a case where multiple new expected target values fall within the optimal working area, the new expected target value closest to a median of the optimal working area is selected to determine the magnification factors K′.

Compared with the prior art, the invention completes calculation feedback and changes of feature configurations by means of the conversion time between rows to achieve continuous adjustment in a single frame of image, thus realizing continuous and dynamic tracking of the image. The invention has the following technical effects: first, by adopting a single-frame HDR mode, the frame rate is not decreased, and interference caused by information differences between different frames is avoided; second, different positions and scenes in frames are tracked in real time by means of different gain configurations and dynamic quantization ranges, thus preventing underexposure or overexposure of information.

### BRIEF DESCRIPTION OF THE DRAWINGS

FIG. 1A and FIG. 1B are schematic diagrams of functional modules of a machine vision measurement system according to the invention.

FIG. 2 is a schematic diagram of the working process of the machine vision measurement system according to the invention.

FIG. 3 is a schematic diagram of the working process of a HDR system module.

### DESCRIPTION OF THE EMBODIMENTS

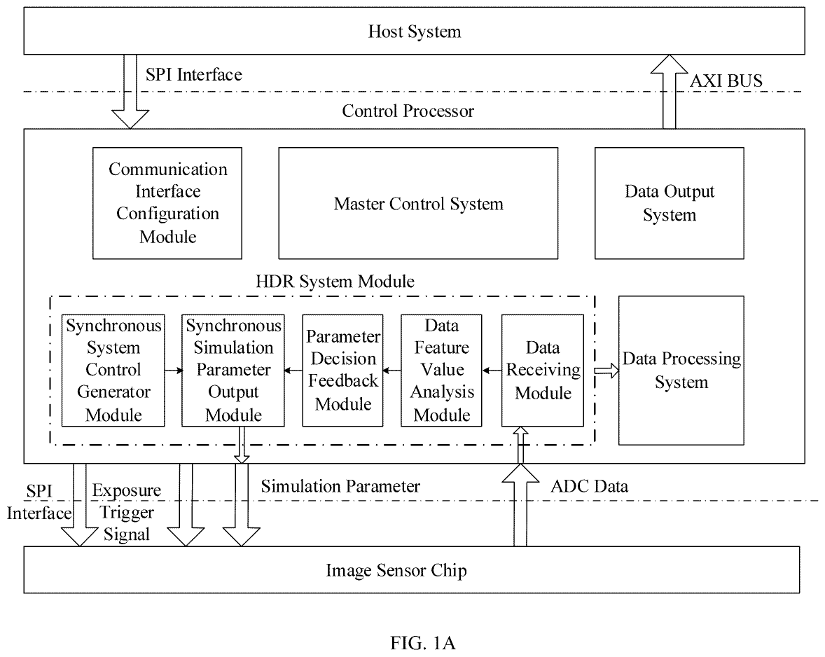

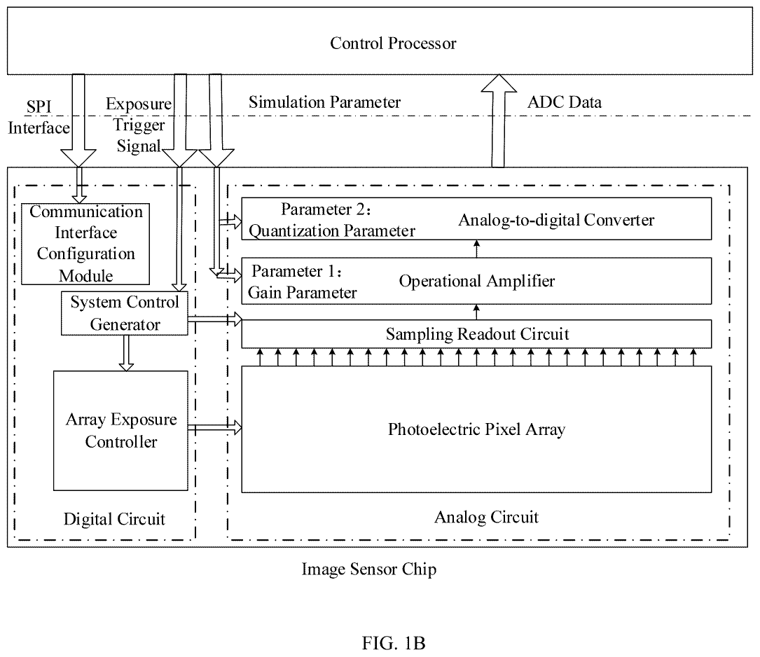

Referring to FIG. 1A and FIG. 1B which are schematic diagrams of functional modules of a machine vision measurement system according to the invention, the machine vision measurement system according to the invention includes:
a host system, configured for receiving an input instruction from a user, sending the input instruction to a control processor, receiving data output by the control processor and displaying the data to the user;
the control processor, including a communication interface configuration module, a master control system, a data output system and a data processing system, wherein the working principle of the communication interface configuration module, the master control system, the data output system and the data processing system has been described in the prior art and thus will not be detailed here; the control processor further includes a HDR system module; and
an image sensor chip, including a photoelectric sensor array, a sampling readout circuit, an operational amplifier, an analog-to-digital converter, an array exposure controller, a system control generator and a communication interface configuration module, wherein the working principle and method of the photoelectric sensor array, the sampling readout circuit, the operational amplifier, the analog-to-digital converter, the array exposure controller, the system control generator and the communication interface configuration module have been disclosed in the prior art and will not be detailed here.

The improvement of the invention lies in that the HDR system module is additionally arranged in the control processor. The HDR system module includes:
a data receiving module, configured for synchronizing a row starting point and ending point on the basis of the number of row data and denoting corresponding data by valid/invalid flags;
a data feature value analysis module, configured for carrying out feature value extraction on serial data, wherein a feature value may be one or a combination of multiple of a maximum value, a minimum value, a mean, a contrast, a gray spot size of pixels;
a parameter decision feedback module, configured for determining whether the extracted feature value is located in a preset optimal working area, keeping simulation parameters of the image sensor chip unchanged if so, adjusting the simulation parameters of the image sensor chip along a downtrend of the feature value if the feature value is located above the optimal working area, and adjusting the simulation parameters of the image sensor chip along an uptrend of the feature value if the feature value is located below the optimal working area;
a synchronous system control generator module, configured for tracking a control working time sequence of the image sensor chip and starting up a data input detection window; and
a synchronous simulation parameter output module, configured for updating the simulation parameters of the image sensor chip on the basis of a signal of the synchronous system control generator module, wherein in a specific implementation, the simulation parameters include a gain parameter and a quantization parameter.

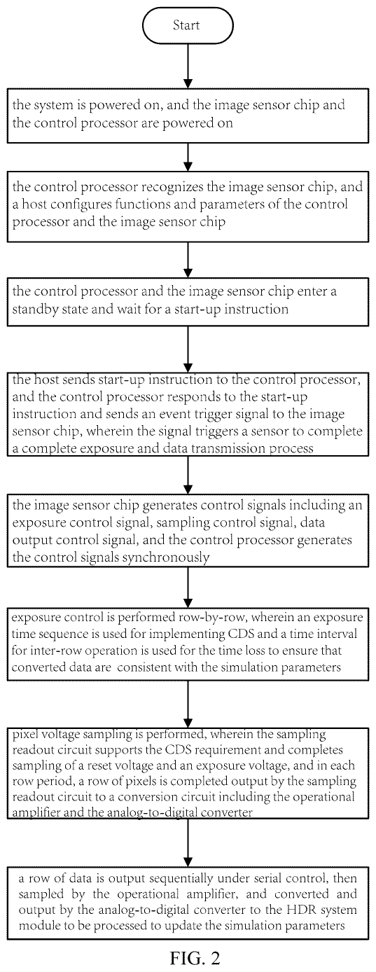

Referring to FIG. 2 which is a schematic diagram of the working process of the machine vision measurement system according to the invention, the working process of the machine vision measurement system according to the invention includes the following steps:
the system is powered on, and the image sensor chip and the control processor are powered on;
the control processor recognizes the image sensor chip, and a host configures functions and parameters of the control processor and the image sensor chip;
the control processor and the image sensor chip enter a standby state and wait for a start-up instruction;
the host sends the start-up instruction to the control processor, and the control processor responds to the start-up instruction and sends an event trigger signal to the image sensor chip, wherein the signal triggers a sensor to complete a complete exposure and data transmission process;
the image sensor chip generates control signals including an exposure control signal, sampling control signal, data output control signal, and the control processor generates the control signals synchronously;
exposure control is performed row-by-row, wherein an exposure time sequence is used for implementing correlated double sampling (CDS), and a time interval for inter-row operation is used for the time loss in the HDR process, to ensure that converted data are matched and consistent with the simulation parameters;
pixel voltage sampling is performed, wherein the sampling readout circuit supports the CDS requirement and completes sampling of a reset voltage and an exposure voltage, and in each row period, a row of pixels is completed output by the sampling readout circuit to a conversion circuit including the operational amplifier and the analog-to-digital converter; and
a row of data is output sequentially under serial control, then sampled by the operational amplifier, and converted and output by the analog-to-digital converter to the HDR system module to be processed to update the simulation parameters.

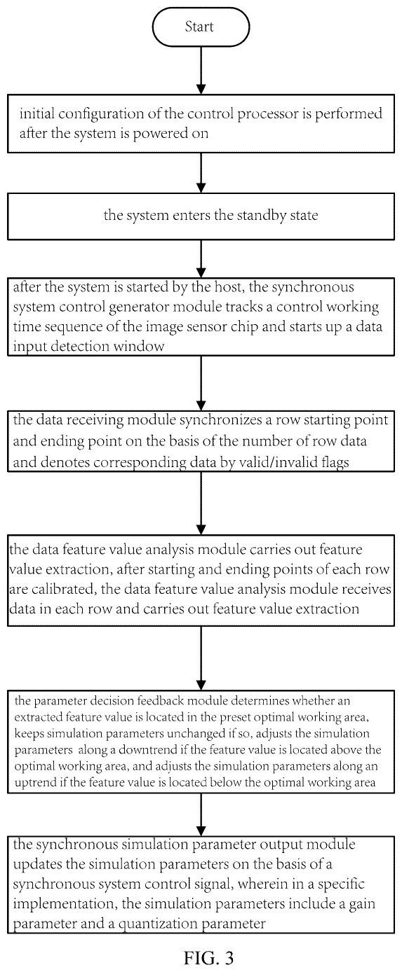

Referring to FIG. 3 which is a schematic diagram of the working process of the HDR system module, the specific working process of the HDR system module includes the following steps:

After the system is powered on, initial configuration of the control processor is performed, wherein the HDR system module acquires a decision range parameter, sets an optimal working area of pixel features and configures specification information of the image sensor chip array to synchronize control/data transmission and other processes of the image sensor chip and the control processor, so as to allow the control processor to synchronously track sequential operations of the image sensor chip to accurately predict the working node where the image sensor chip is located. Wherein, the decision range parameter may be specifically configured and updated by means of the host. Because a photocurrent will be produced after a photoelectric sensor is exposed to light, the photocurrent will increase with the increase in light intensity, a formed response voltage will increase with the increase in the discharge time, and finally, the voltage will undergo a linear increase stage, a saturation stage and an overexposure stage according to device parameters. In the saturation stage and the overexposure stage, the voltage change is in a nonlinear relationship with the light intensity with time, so the saturation stage and the overexposure stage cannot reflect the actual intensity contrast. According to the working principle of the device and the requirements of data processing for a data feature range, the decision parameter range is generally a data range in a non-saturated region and close to a linear region. For example, in a case where the gray bit depth is 8 bit, the decision parameter range is approximately [140,180].

The system enters the standby state;
after the system is started by the host, the synchronous system control generator module tracks a control working time sequence of the image sensor chip and starts up a data input detection window;
the data receiving module synchronizes a row starting point and ending point on the basis of the number of row data and denotes corresponding data by valid/invalid flags;
the data feature value analysis module carries out feature value extraction on serial data, that is, after a starting point and the ending point of each row are calibrated, the data feature value analysis module receives data in each row and carries out feature value extraction, wherein the feature value may be one or a combination of multiple of a maximum value, a mean or a contrast of pixels, and preferably, the feature value is the maximum value of the pixels;
the parameter decision feedback module determines whether an extracted feature value is located in the preset optimal working area, keeps simulation parameters of the image sensor chip unchanged if so, adjusts the simulation parameters of the image sensor chip along a downtrend of the feature value if the feature value is located above the optimal working area, and adjusts the simulation parameters of the image sensor chip along an uptrend of the feature value if the feature value is located below the optimal working area;
the synchronous simulation parameter output module updates the simulation parameters of the image sensor chip on the basis of a synchronous system control signal, wherein in a specific implementation, the simulation parameters include a gain parameter and a quantization parameter.

The above implementation process is described below with reference to a specific embodiment where the simulation parameter 1 is a gain parameter Gain, the simulation parameter 2 is a quantization parameter adc_ref, a corresponding quantization voltage is Vref, an exposure voltage is V2 and a conversion formula of the analog-to-digital converter is: the feature value ADC_DATA=the exposure voltage Ve×the gain parameter Gain/(the quantization voltage Vref/1024)=the exposure voltage Ve×the gain parameter Gain×1024/the quantization voltage Vref First, the initial working condition is set, and assume the gain parameter Gain is set to 1, the quantization voltage is set to 1 V and the analog-to-digital converter is set to 10 bit, the feature value ADC_DATA=1024×the exposure voltage Ve/the quantization voltage Vref.

In the decision process, with a single value as an example, assume the optimal working area is a range [Dmin, Dmax], in a case where the feature value ADC_DATA is between Dmin and Dmax, the two simulation parameters are kept unchanged; in a case where the feature value ADC_DATA is less than Dmin, the feature value may be increased by increasing the gain parameter Gain and decreasing the quantization voltage Vref; or, in a case where the feature value ADC_DATA is greater than Dmin, the feature value ADC_DATA may be decreased by decreasing the gain parameter Gain and increasing the quantization voltage Vref.

Limited the design condition, the gain parameter Gain and the quantization voltage Vref cannot be completely continuous and may be any values. For the sake of brevity, the parameters may be determined by using a look-up table. According to the above formula: the feature value DC_DATA=the exposure voltage Ve×the gain parameter Gain/(the quantization voltage Vref/1024)=the exposure voltage Ve×the gain parameter Gain×1024/the quantization voltage Vref=the exposure voltage Ve×1024×the gain parameter Gain/the quantization voltage Vref, the gain parameter Gain/quantization voltage Vref=the equivalent gain K, it can be obtained that the feature value DC_DATA=the exposure voltage Ve×1024×the equivalent gain K. In actual application, the gain parameter Gain has a greater influence on the feature value ADC_DATA. In a specific design, the gain parameter Gain may be designed to one, two or four times. In a specific design, the quantization voltage Vref may be set to 0.8, 1, 1.2 or 1.4. In this way, the value table of the equivalent gain K, as shown in Table 1, may be established according to a formula: the equivalent gain K=the gain parameter Gain/quantization voltage Vref, Apparently, the values of the gain parameter Gain and the quantization voltage Vref in Table 1 are merely illustrative and may be refined to obtain more values of the equivalent gain K to make the adjustment process more accurate.

TABLE 1

| | | gain | | |
|---|---|---|---|---|
| K (equivalent gain) | | 1 | 2 | 4 |
| Quantization | 0.8 | 1.25 | 2.5 | 5 |
| range | 1 | 1 | 2 | 4 |
| adc_ref | 1.2 | 0.83333333 | 1.66666667 | 3.33333333 |
| | 1.4 | 0.71428571 | 1.42857143 | 2.85714286 |

After the value table of the equivalent gain K is established, the simulation parameters are updated as follows:

The data feature value analysis module carries out feature value extraction on serial data, that is, after each row of data is received, a feature value V₀ of the current row is extracted.

If the feature value of the current row is located in the set optimal working area, the simulation parameters are kept unchanged; otherwise, the current equivalent gain K₀ is obtained, wherein the equivalent gain K₀=the gain parameter Gain/the quantization voltage Vref.

Then, new expected target values corresponding to different amplification factors in Table 2 are enumerated; after the equivalent gain K₀ is determined, an expected equivalent gain K₁ may be determined according to Table 2. It may be known, according to Table 1, that the value range of the equivalent gain K₀ and the value range of the expected equivalent gain K₁ are the same, such that after the equivalent gain K₀ is determined, 12 possible values of the expected equivalent value K₁ may be obtained according to Table 2. Assume the equivalent gain K₀ is 1.25, the expected equivalent gain K₁ may be 1.25, 1, 0.833, 0.714, 2.5, 2, 1.66667, 1.4286, 5, 4, 3.33 and 2.857. Then, the amplification factor is calculated: the amplification factor K′=the expected equivalent gain K1/the equivalent gain K0. After that, a new expected target value is obtained: the new expected target value=the feature value of the current row V₀×the amplification factor K′.

TABLE 2

| K₁ | K₀ | K′ = K₁/K₀ | K₁ | K₀ | K′ = K₁/K₀ | K₁ | K₀ | K′ = K₁/K₀ |
|---|---|---|---|---|---|---|---|---|
| 1.25 | 1.25 | 1 | 1.25 | 2.5 | 0.5 | 1.25 | 5 | 0.25 |
| 1 | 1.25 | 0.8 | 1 | 2.5 | 0.4 | 1 | 5 | 0.2 |
| 0.833 | 1.25 | 0.6664 | 0.833 | 2.5 | 0.3332 | 0.833 | 5 | 0.1666 |
| 0.714 | 1.25 | 0.5712 | 0.714 | 2.5 | 0.2856 | 0.714 | 5 | 0.1428 |
| 2.5 | 1.25 | 2 | 1.6 | 2.5 | 0.64 | 2.5 | 5 | 0.5 |
| 2 | 1.25 | 1.6 | 2 | 2.5 | 0.8 | 2 | 5 | 0.4 |
| 1.66667 | 1.25 | 1.333336 | 2.4 | 2.5 | 0.96 | 1.66667 | 5 | 0.333334 |
| 1.4286 | 1.25 | 1.14288 | 2.8 | 2.5 | 1.12 | 1.4286 | 5 | 0.28572 |
| 5 | 1.25 | 4 | 5 | 2.5 | 2 | 5 | 5 | 1 |
| 4 | 1.25 | 3.2 | 4 | 2.5 | 1.6 | 4 | 5 | 0.8 |
| 3.333 | 1.25 | 2.6664 | 3.333 | 2.5 | 1.3332 | 3.333 | 5 | 0.6666 |
| 2.857 | 1.25 | 2.2856 | 2.857 | 2.5 | 1.1428 | 2.857 | 5 | 0.5714 |
| 1.25 | 1 | 1.25 | 1.25 | 2 | 0.625 | 1.25 | 4 | 0.3125 |
| 1 | 1 | 1 | 1 | 2 | 0.5 | 1 | 4 | 0.25 |
| 0.833 | 1 | 0.833 | 0.833 | 2 | 0.4165 | 0.833 | 4 | 0.20825 |
| 0.714 | 1 | 0.714 | 0.714 | 2 | 0.357 | 0.714 | 4 | 0.1785 |
| 2.5 | 1 | 2.5 | 2.5 | 2 | 1.25 | 2.5 | 4 | 0.625 |
| 2 | 1 | 2 | 2 | 2 | 1 | 2 | 4 | 0.5 |
| 1.66667 | 1 | 1.66667 | 1.66667 | 2 | 0.833335 | 1.66667 | 4 | 0.416668 |
| 1.4286 | 1 | 1.4286 | 1.4286 | 2 | 0.7143 | 1.4286 | 4 | 0.35715 |
| 5 | 1 | 5 | 5 | 2 | 2.5 | 5 | 4 | 1.25 |
| 4 | 1 | 4 | 4 | 2 | 2 | 4 | 4 | 1 |
| 3.333 | 1 | 3.333 | 3.333 | 2 | 1.6665 | 3.333 | 4 | 0.83325 |
| 2.857 | 1 | 2.857 | 2.857 | 2 | 1.4285 | 2.857 | 4 | 0.71425 |
| 1.25 | 0.8333 | 1.50006 | 1.25 | 1.66667 | 0.749999 | 1.25 | 3.333 | 0.375038 |
| 1 | 0.8333 | 1.200048 | 1 | 1.66667 | 0.599999 | 1 | 3.333 | 0.30003 |
| 0.833 | 0.8333 | 0.99964 | 0.833 | 1.66667 | 0.499799 | 0.833 | 3.333 | 0.249925 |
| 0.714 | 0.8333 | 0.856834 | 0.714 | 1.66667 | 0.428399 | 0.714 | 3.333 | 0.214221 |
| 2.5 | 0.8333 | 3.00012 | 2.5 | 1.66667 | 1.499997 | 2.5 | 3.333 | 0.750075 |
| 2 | 0.8333 | 2.400096 | 2 | 1.66667 | 1.199998 | 2 | 3.333 | 0.60006 |
| 1.66667 | 0.8333 | 2.000084 | 1.66667 | 1.66667 | 1 | 1.66667 | 3.333 | 0.500051 |
| 1.4286 | 0.8333 | 1.714389 | 1.4286 | 1.66667 | 0.857158 | 1.4286 | 3.333 | 0.428623 |
| 5 | 0.8333 | 6.00024 | 5 | 1.66667 | 2.999994 | 5 | 3.333 | 1.50015 |
| 4 | 0.8333 | 4.800192 | 4 | 1.66667 | 2.399995 | 4 | 3.333 | 1.20012 |
| 3.333 | 0.8333 | 3.99976 | 3.333 | 1.66667 | 1.999796 | 3.333 | 3.333 | 1 |
| 2.857 | 0.8333 | 3.428537 | 2.857 | 1.66667 | 1.714197 | 2.857 | 3.333 | 0.857186 |
| 1.25 | 0.714 | 1.7507 | 1.25 | 1.4286 | 0.874983 | 1.25 | 2.857 | 0.437522 |
| 1 | 0.714 | 1.40056 | 1 | 1.4286 | 0.699986 | 1 | 2.857 | 0.350018 |
| 0.833 | 0.714 | 1.166667 | 0.833 | 1.4286 | 0.583088 | 0.833 | 2.857 | 0.291565 |
| 0.714 | 0.714 | 1 | 0.714 | 1.4286 | 0.49979 | 0.714 | 2.857 | 0.249912 |
| 2.5 | 0.714 | 3.501401 | 2.5 | 1.4286 | 1.749965 | 2.5 | 2.857 | 0.875044 |
| 2 | 0.714 | 2.80112 | 2 | 1.4286 | 1.399972 | 2 | 2.857 | 0.700035 |
| 1.66667 | 0.714 | 2.334272 | 1.66667 | 1.4286 | 1.166646 | 1.66667 | 2.857 | 0.583364 |
| 1.4286 | 0.714 | 2.00084 | 1.4286 | 1.4286 | 1 | 1.4286 | 2.857 | 0.500035 |
| 5 | 0.714 | 7.002801 | 5 | 1.4286 | 3.49993 | 5 | 2.857 | 1.750088 |
| 4 | 0.714 | 5.602241 | 4 | 1.4286 | 2.799944 | 4 | 2.857 | 1.40007 |
| 3.333 | 0.714 | 4.668067 | 3.333 | 1.4286 | 2.333053 | 3.333 | 2.857 | 1.166608 |
| 2.857 | 0.714 | 4.001401 | 2.857 | 1.4286 | 1.99986 | 2.857 | 2.857 | 1 |

The amplification factor K′ is determined according to the new expected target value within the optimal working area; then, the expected equivalent gain K′ is determined; and then, the gain parameter Gain and the quantization parameter adc_ref corresponding to the expected equivalent gain K′ are determined according to Table 1, such that the two simulation parameters of the image sensor chip are updated.

In the above step, in a case where multiple new expected target values fall within the optimal working area, the new expected target value closest to the median of the optimal working area may be selected.

Compared with the prior art, the invention completes calculation feedback and changes of feature configurations by means of the conversion time between rows to achieve continuous adjustment in a single frame of image, thus realizing continuous and dynamic tracking of the image. The invention has the following technical effects: first, by adopting a single-frame HDR mode, the frame rate is not decreased, and interference caused by information differences between different frames is avoided; second, different positions and scenes in frames are tracked in real time by means of different gain configurations and dynamic quantization ranges, thus preventing underexposure or overexposure of information.

It is understandable that for those ordinarily skilled in the art, equivalent substitutions or modifications may be made according to the technical solutions and inventive concept of the invention, and all these modifications or substitutions should also fall within the protection scope of the appended claims.

What is claimed is:

1. A machine vision measurement system, comprising an image sensor chip and a control processor for cooperative use, the image sensor chip comprising a photoelectric sensor array, a sampling readout circuit, an operational amplifier, an analog-to-digital converter, an array exposure controller, a system control generator and a communication interface configuration module, and the control processor comprising a communication interface configuration module, a master control system, a data output system and a data processing system, wherein the control processor further comprises a HDR system module, and the HDR system module comprises:
a data receiving module, configured for synchronizing a row starting point and ending point on the basis of the number of row data;
a data feature value analysis module, configured for carrying out feature value extraction on serial data, wherein to be specific, the data feature value analysis module, after calibrating a starting point and an ending point of each row, receives data of each row and then carries out feature value extraction;
a parameter decision feedback module, configured for determining whether an extracted feature value of a current row is located in a preset optimal working area, keeping simulation parameters of the image sensor chip unchanged if so, adjusting the simulation parameters of the image sensor chip along a downtrend of the feature value if the feature value is located above the optimal working area, and adjusting the simulation parameters of the image sensor chip along an uptrend of the feature value if the feature value is located below the optimal working area;
a synchronous system control generator module, configured for tracking a control working time sequence of the image sensor chip and starting up a data input detection window; and
a synchronous simulation parameter output module, configured for updating the simulation parameters of the image sensor chip on the basis of a signal of the synchronous system control generator module.

2. The machine vision measurement system according to claim 1, wherein the feature value is one of a maximum value, a mean or a contrast of pixels.

3. The machine vision measurement system according to claim 2, wherein the simulation parameters comprise a gain parameter and a quantization parameter.

4. A method for adjusting simulation parameters of an image sensor chip by the machine vision measurement system according to claim 1, comprising:
acquiring a decision range parameter, and setting an optimal working area of pixel features;
after the system is started, tracking a control working time sequence of the image sensor chip and starting up a data input detection window, by the synchronous system control generator module;
synchronizing, by the data receiving module, a row starting point and ending point on the basis of the number of row data;
carrying out, by the data feature value analysis module, feature value extraction on serial data, wherein the data feature value analysis module, after calibrating a starting point and an ending point of each row, receives data of each row and then carries out feature value extraction;
determining whether an extracted feature value of a current row is located in the preset optimal working area, keeping simulation parameters of the image sensor chip unchanged if so, adjusting the simulation parameters of the image sensor chip along a downtrend of the feature value if the feature value is located above the optimal working area, and adjusting the simulation parameters of the image sensor chip along an uptrend of the feature value if the feature value is located below the optimal working area, by the parameter decision feedback module; and
updating, by the synchronous simulation parameter output module, the simulation parameters of the image sensor chip on the basis of a synchronous system control signal.

5. The method according to claim 4, wherein the feature value is one of a maximum value, a mean or a contrast of pixels.

6. The method according to claim 4, wherein the simulation parameters comprise a gain parameter and a quantization parameter.

7. The method according to claim 4, wherein adjusting the simulation parameters of the image sensor chip along the uptrend of the feature value comprises increasing a gain parameter and decreasing a quantization parameter, and adjusting the simulation parameters of the image sensor chip along the downtrend of the feature value comprises decreasing the gain parameter and increasing the quantization parameter.

8. The method according to claim 4, wherein the simulation parameters comprise a gain parameter and a quantization parameter, and the method for adjusting the simulation parameter of the image sensor chip comprises:
establishing a value table of an equivalent gain according to possible values of the gain parameter and a quantization voltage, wherein the equivalent gain is a ratio of the gain parameter to the quantization voltage;
acquiring a feature value V₀ of a current row and an equivalent gain K₀;
determining a magnification factor K′, wherein the magnification factor K′ is a quotient of an expected equivalent gain K₁ and the equivalent gain K₀;
enumerating new expected target values corresponding to all magnification factors, wherein the new expected target values are obtained by multiplying the feature value V₀ of the current row by the magnification factors K′; and
determining the amplification factor K′ according to the new expected target value within the optimal working area; then, determining the expected equivalent gain K′; and then, determining the gain parameter and the quantization parameter corresponding to the expected equivalent gain K′.

9. The method according to claim 8, wherein in a case where multiple new expected target values fall within the optimal working area, the new expected target value closest to a median of the optimal working area is selected to determine the magnification factors K′.
